(19) United States
(12) Patent Application Publication
(10) Pub. No.: US 2017/0259910 A1
(43) Pub. Date: Sep. 14, 2017

(54) Landing Gear for a Light Aircraft, Comprising at Least Two Wheels

(71) Applicant: BERINGER AERO, Tallard (FR)

(72) Inventor: Rémi Beringer, Tallard (FR)

(21) Appl. No.: 15/528,725

(22) PCT Filed: Nov. 24, 2015
(86) PCT No.: PCT/FR2015/053191

§ 371 Date: May 22, 2017

(30) Foreign Application Priority Data
Nov. 24, 2014 (FR) 1461324

(51) Int. Cl. B64C 25/36; B64C 25/06; B64C 25/04; B64C 25/60

(52) U.S. Cl. CPC B64C 25/36; B64C 25/60; B64C 25/06; B64C 25/04

(57) ABSTRACT

The landing gear for a Piper Cub® light aircraft, comprises at least two wheels, is attached to a part of the fuselage in front of the center of gravity, and has a fixed tubular reinforcement that is generally triangular in shape, of which the apex is turned downwards, the ends of the base of the reinforcement and the apex of same being coupled, with articulation capability, to a suspension system linked to the wheels. Each end of the base of the reinforcement is angularly coupled to a wheel, by means of a damping member, while the apex of said reinforcement is coupled symmetrically to each of the wheels, by means of a connecting rod.

### TECHNOLOGICAL FIELD

The present disclosure is connected with the general aviation technical sector, and more specifically relates to light aircraft, generally under 5.7 tons, of the Piper Cub®, Supercub® and derived type. More specifically, the present disclosure relates to landing gear for this type of aircraft.

### BACKGROUND

According to the prior art, the landing gear for these light aircraft, Piper® type, essentially comprise a reinforcement, generally triangular in shape, attached to a part of the fuselage forward of the center of gravity. This reinforcement, generally made from tubular elements, has an apex angle of between about 90 and 120° , where the apex, after attachment of the reinforcement, is turned downwards, meaning towards the ground. The ends of the base of the reinforcement and the apex thereof are coupled, with articulation capability, to a system of struts and dampers connected to the aircraft's wheels. For example, as shown in FIGS. 1, 2 and 3, the apex (1a) of the reinforcement (1) is coupled with free and symmetrical articulation to each of the aircraft's wheels (R) by means of a damping member (a). Each end (1b) and (1c) of the base of the reinforcement (1) is angularly coupled to each of the wheels (R) by means of a compression strut (b). Considering this landing gear design, it appears that it does not absorb the energy at the moment of impact, but is only capable of releasing it. The result of this is a scuffing of the tires, and significant stresses absorbed by the fuselage at the moment of impact on the ground, considering the poor quality of the damping of the shocks.

Additionally, the patent U.S. Pat. No. 2,233,191 describes a landing gear for light aircraft comprising a fixed tubular reinforcement of general triangular shape whose apex is turned downwards, and a flat vertical reinforcement at the lower end of which a plate is attached, under the apex of the tubular reinforcement. Such a reinforcement system has a relatively complex structure.

The ends of the base of the tubular reinforcement and the plate attached to the flat reinforcement are coupled, with articulation capability, to a suspension system connected to the wheels. Each end of the base of the tubular reinforcement is angularly coupled to a wheel by means of a damping member, whereas the plate attached to the flat reinforcement is connected to each wheel by a relatively thin torsion strut.

Each damping member comprises a barrel articulated to the tubular reinforcement and a piston integral with a stub axle supporting the wheel. The barrel comprises a fork provided with two branches of composite material of relatively complex and costly construction. Each end of the base of the tubular reinforcement comprises two pairs of lugs spaced apart, between which the two branches of the fork are mounted with articulation capability. The torsion torque transmitted from each wheel to the fuselage is taken up, both within the damping member and also at the articulation between the fork and the spaced lugs.

Such pairs of spaced lugs generally do not equip the original fuselage of light aircraft, such as the Piper Cub®. In other words, a modification of the original fuselage is necessary to mount the landing gear onto the aircraft, which complicates the installation of said gear. Additionally, the risk of in-service accident increases if such a change is not performed perfectly.

### SUMMARY OF THE DISCLOSURE

The object of the disclosed embodiments is to remedy the above drawbacks in a simple, safe, effective and rational manner.

The problem that the disclosed embodiments propose to resolve is to propose a landing gear for this type of light aircraft suited to absorbing the energy from impact with a particular objective of improving safety during landing.

To resolve such a problem, a landing gear for light aircraft, of Piper Cub® type, was designed and perfected comprising at least two wheels, with the landing gear attached to a part of the fuselage in front of the center of gravity of the aircraft, and having a fixed tubular reinforcement that is generally triangular in shape, of which an apex is turned downward and a base positioned upward, the ends of the base and the apex being coupled, with articulation capability, to a suspension system connected to the wheels.

According to embodiments, each end of the base of the reinforcement is angularly coupled to a wheel, by means of a damping member, whereas the apex of said reinforcement is symmetrically coupled to each of the wheels by means of a connecting rod.

It can be seen from these characteristics that the effectiveness of the damping is increased at least 50% compared to conventional landing gear, according to the characteristics of the prior technical art previously disclosed. In fact, the kinematics, as claimed, make it possible to obtain at take-off, meaning when the wheels are no longer in contact with the ground, a height between the fuselage and the base of the wheels greater than that corresponding to a landing gear according to the prior art, whereas the height between the fuselage and the base of the wheels at the moment of landing is less according to the characteristics of the described embodiments than that presented by the landing gear according to the prior art.

In comparison with the specific landing gear described in the patent U.S. Pat. No. 2,233,191, the landing gear described presently has a relatively simple construction and does not require modification of the original fuselage.

According to other characteristics of the described embodiments, taken in isolation or in combination:
Each connecting rod has a first end pivotably coupled to the apex of the reinforcement.
Each connecting rod has a second end coupled with articulation capability to a fixed fitting of the corresponding wheel.
The second end of the connecting rod forms a fork connected by a rod to the fixed fitting of the corresponding wheel.
Each connecting rod has a second end securely coupled to a fitting of the corresponding wheel.
Each damping member has a first end coupled with articulation capability to the ends of the base of the reinforcement.
The first end of each damping member is coupled with articulation capability to the ends of the base of the reinforcement between two spaced lugs integral with the fuselage.
Each damping member has a second end angularly coupled fixedly to a fitting of the wheel.
Each damping member has a second end coupled angularly, with articulation capability, to a fitting of the wheel.
The damping member is a hydraulic cylinder, made up of a barrel articulated to the ends of the base of the reinforcement, and a sliding rod coupled to a fitting of the wheel.

The object of the embodiments herein is also a light aircraft, Piper Cub® type, comprising a landing gear such as described above.

According to a first embodiment, the landing gear is mounted on the original attachment elements equipping the fuselage part.

According to a first embodiment, the landing gear is mounted on an independent support capable of being attached to the part of the fuselage.

An object of the described embodiments is also a method for mounting a landing gear such as described above on a fuselage part of a Piper Cub® type light aircraft.

According to a first embodiment, the landing gear is mounted without modification of the original attachment elements equipping said fuselage part.

According to a second embodiment, the landing gear is mounted on an independent support, which is attached to said fuselage part.

### BRIEF DESCRIPTION OF THE FIGURES

The embodiments are disclosed below in more detail using the figures from the attached drawings, wherein:

FIGS. 1, 2 and 3 are schematic views of the landing gear according to the prior art of the type of those equipping light aircraft, such as Piper Cub®, where FIG. 1 shows the landing gear at the moment of landing, FIG. 2 in static position and FIG. 3 in take-off position, meaning when the wheels are about to leave the ground or have already left the ground.

FIGS. 4, 5 and 6 are the views corresponding to FIGS. 1, 2 and 3 in the case of the landing gear, showing the effectiveness of the damping.

FIG. 7 is a front view in a larger scale of the landing gear;

FIG. 8 is a side view corresponding to FIG. 7;

FIG. 9 is a partial plan view according to FIG. 8;

FIGS. 10 and 11 are partial views of the landing gear in the area of the junction of the damping member and the connecting rod with the stub axle of the wheel; in FIG. 10, the damper is fixedly coupled to the stub axle and the connecting rod is coupled, with articulation capability, to said stub axle, while in FIG. 11, the damper is coupled, with articulation capability, to the stub axle and the traction bar is securely coupled to said stub axle;

FIG. 12 is a partial view from FIG. 7 in a larger scale showing only the damping member, the connecting rod and the wheel located on one side of the landing gear;

FIG. 13 is a section along the line XIII-XIII in FIG. 12 showing the articulation between the connecting rod and the stub axle;

FIG. 14 is a side view along arrow XIV in FIG. 12;

FIG. 15 is a larger scale view of the detail XV in FIG. 14;

FIG. 16 is a larger scale view of the detail XVI in FIG. 14.

### DETAILED DESCRIPTION

As indicated, the landing gear according to the described embodiments applies to all types of light aircraft, generally under 5.7 tons, of Piper Cub® type, for example, without however excluding other types of aircraft, such as cited below for information and without limitation, specifically: Super Cub®, Aviat Husky®, Champion Aircraft®, Legend Cub®, Just Aircraft®, Cub Crafters®, Zlin Savage®, Bearhawk Aircraft®, Maule®, Avid Flyer®, etc.

It will be remembered, for better understanding, that this type of landing gear comprises a tubular reinforcement (1), of general triangular shape, secured on a part of the fuselage (F), forward of the center of gravity. Said triangular reinforcement (1) is connected in free articulation, at its apex (1a) and at each of the ends (1b) and (1c) of the base thereof, to the wheels (R) of the aircraft under consideration via suspension members. The apex (1a) of the triangular reinforcement is directed downward, meaning in the direction of the ground. The base of the triangular reinforcement is positioned upward, horizontally, from the side of the fuselage (F).

Each end (1b) and (1c) of the reinforcement base (1) is angularly coupled to each of the wheels (R) by means of a damping member (2). The apex (1a) of the reinforcement (1) is symmetrically coupled to each of the wheels by means of a connecting rod (3).

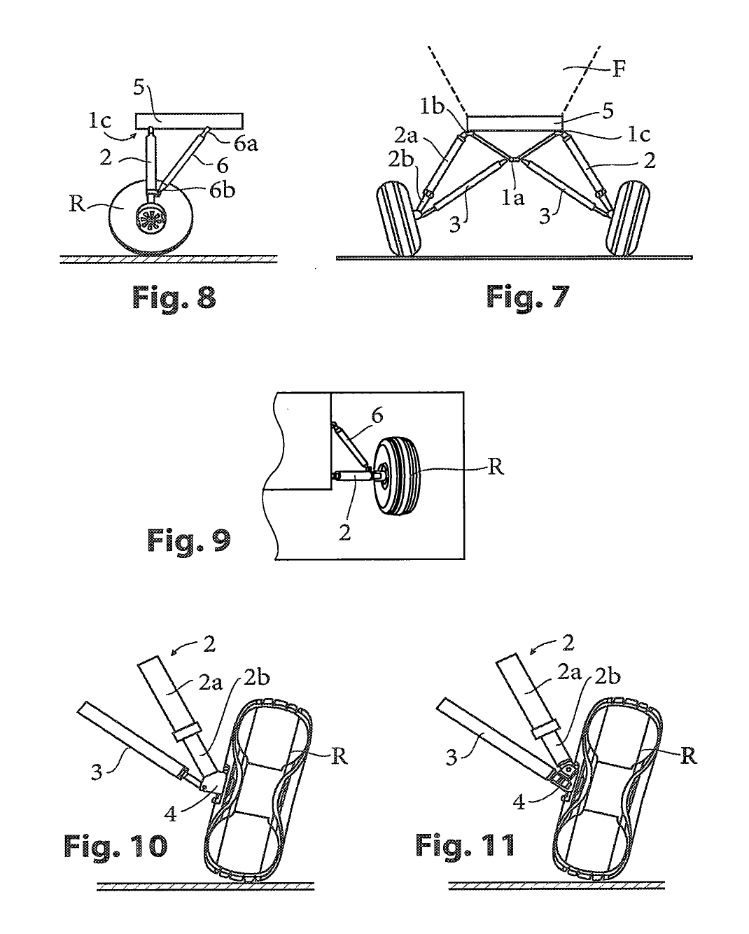

As FIG. 7 in particular shows, one end of each damping member (2) is coupled with articulation capability to the ends (1b) and (1c) of the base of the reinforcement (1). The other end of each damping member (2) is angularly coupled fixedly to a support member (4) such as a stub axle that the hub of the wheel has.

For example, the damping member (2) is made up of a hydraulic cylinder, the barrel (2a) of which is articulated to the ends (1b) and (1c) of the base of the reinforcement (1), while the sliding rod (2b) of the hydraulic cylinder is integral with the stub axle (4). More precisely, the barrel (2a) has an upper end (2c) articulated to one of the ends (1b) or (1c), while the sliding rod (2d) has a lower end (2d) integral with the stub axle (4).

The connecting rods (3) are coupled with articulation capability at each of their ends both to the apex (1a) of the reinforcement (1) according to two equally spaced attachment areas, and also to the stub axle (4) (FIG. 10).

Without going outside the scope of the contemplated embodiments, each damping member (2) can be coupled with articulation capability to the stub axle (4), while each connecting rod is fixedly coupled to said stub axle (4) (variant shown in FIG. 11).

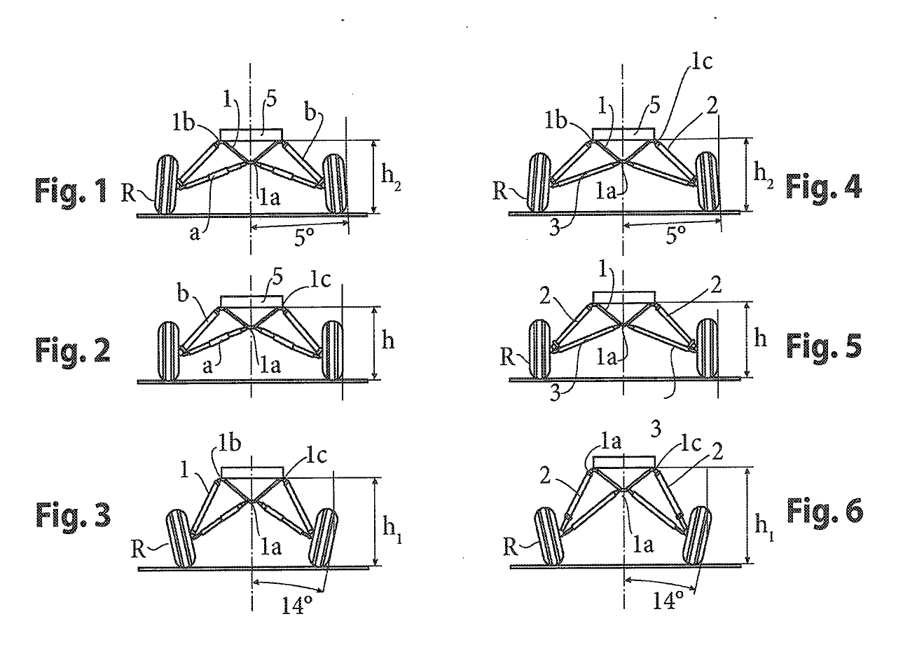

The result of these specific characteristics is that the landing gear makes it possible to obtain a significant improvement of damping effectiveness with absorption of the energy from the impact of the wheels with the ground. In this respect, reference is now made to the various comparative views in FIGS. 1, 2 and 3, which show a conventional landing gear according to the prior art, and FIGS. 4, 5 and 6, which show a landing gear conforming to the contemplated embodiments.

In the example shown, in static position, FIGS. 2 and 5, the landing gear delimits a height (h) of 750 mm between the fuselage (F) and the ground.

At the moment of takeoff, meaning when the wheels leave the ground, said height (h) goes to 858 mm with the landing gear according to the prior art, and 935 mm with the landing gear according to the characteristics of the described embodiments (FIGS. 3 and 6). Let this height be (h1).

At the moment of landing, meaning during contact of the wheels with the ground (FIGS. 1 and 4), said height (h) is 702 mm for a landing gear according to the prior art and 682 mm for a landing gear according to the characteristics of the described embodiments. Let this height be (h2).

From these numeric data, it emerges that for 19° of angle variation at the wheels (5° in landing position and 14° in take-off position), a damping displacement of 156 mm is obtained in the case of a landing gear according to the prior art and a displacement of 253 mm in the case of a landing gear according to the characteristics of the described embodiments.

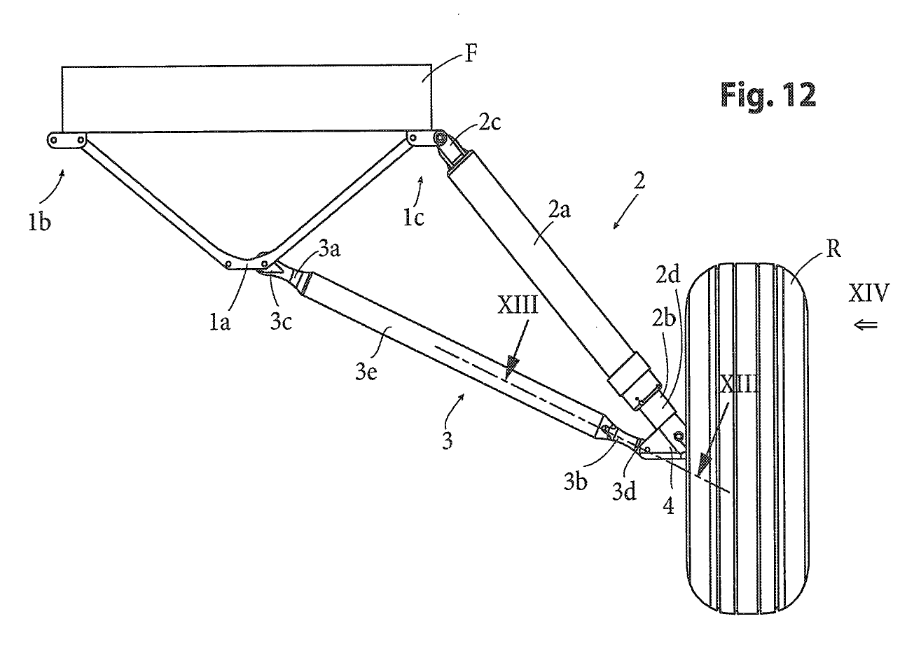

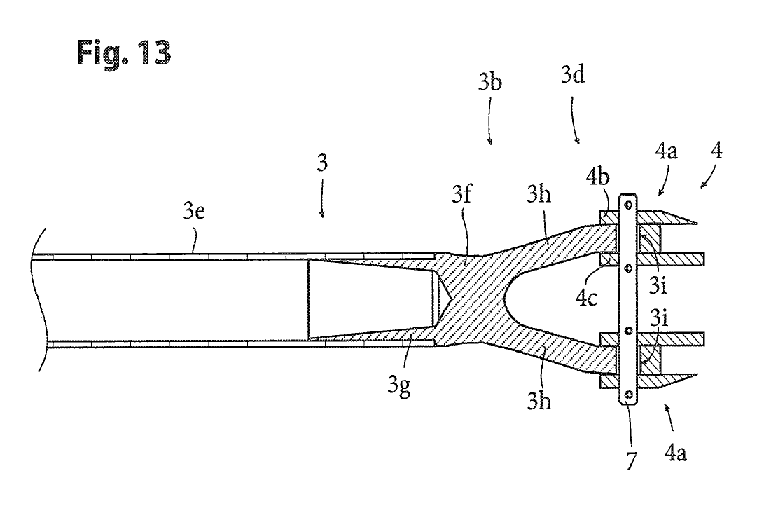

A preferred embodiment of the strut (3) is shown in FIGS. 12 and 13.

The strut (3) is made up of three parts, specifically a first end part (3a) articulated at the apex (1a) to an upper end (3c) of the strut (3), a second end part (3b) articulated to the stub axle (4) at a lower end (3d) of the strut (3) and a median part (3e) connecting the end parts (3a) and (3b).

The median part (3e) has a long hollow tube shape in which the parts (3a) and (3b) are attached, preferably by adhesion, or by any other suitable means.

The part (3a) has a connecting-rod head shape articulated to the apex (1a) of the reinforcement (1).

The part (3b) has a fork shape, with a central body (3f), a tubular part (3g) attached in the median part (3e) and two branches (3h) which extend from the body (3f) opposite to the tubular part (3g). The stub axle (4) comprises two pairs (4a) of spaced lugs (4b) and (4c). Each branch (3h) of the fork is housed between the spaced lugs (4b) and (4c) of one of the pairs (4a). A rod (7) passes through the lugs (4b) and (4c) of each pair (4a) and an orifice (3i) formed in each branch (3h) of the fork. The rod (7) comprises retention means, not shown for reasons of simplification. Thus, the fork shaped part (3b) is connected by the rod (7), with articulation capability, to the stub axle (4) of the corresponding wheel (R).

The rod (3) therefore provides a dual function of offering tensile strength and flexural strength, preventing the rotation of the wheel (R) around the axis of the damping member (2).

The landing gear also comprises a rear strut (6), in particular shown in FIGS. 8, 9, 14 and 16, for each wheel (R). Said strut (6) has an upper end (6a) articulated relative to the fuselage (F) and a lower end (6b) articulated to the damping member (2).

The strut (6) is located rear of the damping member (2) and the connecting rod (3). The strut (6) is inclined relative to the longitudinal, transverse and horizontal planes of the aircraft.

In a known way, the struts (6) serve to improve the effectiveness of the landing gear.

Note that the landing gear, such as defined, can be mounted on a support (5), which could be attached on the corresponding part of the fuselage (F).

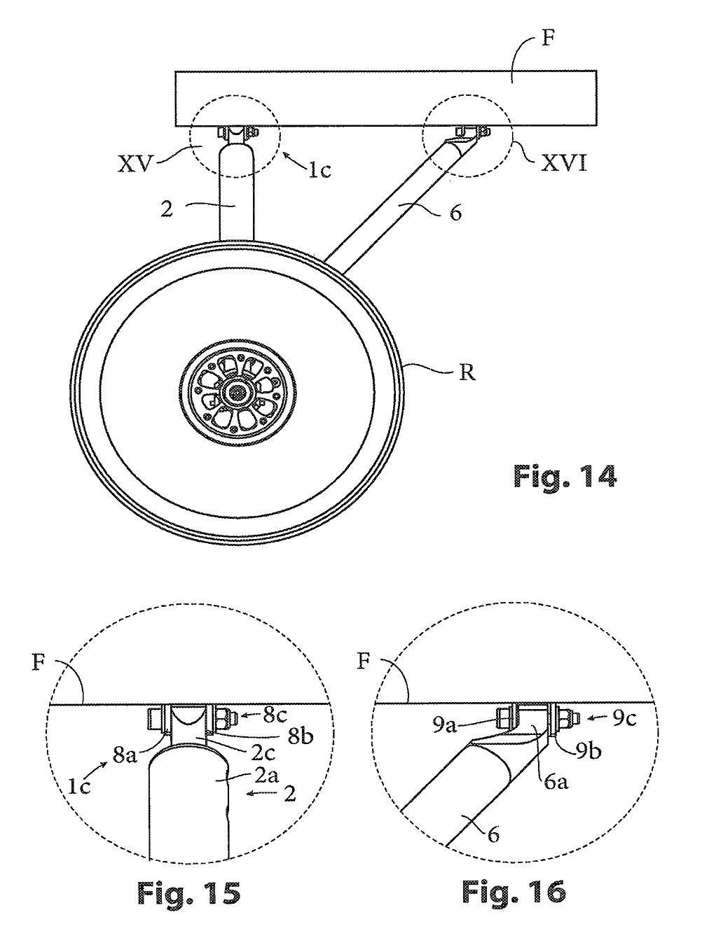

Alternatively, the landing gear according to the contemplated embodiments can also be mounted directly on the fuselage (F) of the aircraft, as shown in FIGS. 14 to 16.

The end (2c) of the damping member (2) is mounted between two spaced lugs (8a) and (8b) rigidly connected with the fuselage (F). A bolting device (8c) connects said end (2c) to the lugs (8a) and (8b), with articulation capability.

Similarly, the end (6a) of the strut (6) is mounted between two spaced lugs (9a) and (9b) integral with the fuselage (F). A bolting device (9c) connects said end (6a) to the lugs (9a) and (9b), with articulation capability.

Advantageously, the lugs (8a), (8b), (9a) and (9b) can be the original attachment elements equipping the fuselage of the aircraft of Piper Cub® type or similar. In that way, the landing gear can be mounted without modification onto the attachment elements equipping the original fuselage (F).

The advantages clearly emerge from the description, in particular, it should be pointed out and recalled that:
absorption of the energy from the impact, instead of releasing it, as is the case according to the landing gear conforming to the prior art;
improvement of the safety during landing;
reduction of the stresses absorbed by the fuselage at the moment of landing;
reduction of the scuffing of the tires at the moment of landing.

1. Landing gear for light aircraft, of Piper Cub® type, comprising at least two wheels, fixed onto a part of the fuselage in front of the center of gravity of the light aircraft, and having a fixed tubular reinforcement of general triangular shape having an apex directed downward and a base positioned upward, the ends of the base and the apex of the reinforcement being coupled with articulation capability to a suspension system linked to the wheels, wherein each end of the base of the reinforcement is angularly coupled to a wheel, by means of a damping member, while the apex of said reinforcement is symmetrically coupled to each of the wheels by means of a connecting rod.

2. Landing gear for light aircraft according to claim 1, wherein each connecting rod has a first end coupled with articulation capability to the apex of the reinforcement.

3. Landing gear for light aircraft according to claim 2, wherein each connecting rod has a second end coupled with articulation capability to a fixed fitting of the corresponding wheel.

4. Landing gear for light aircraft according to claim 3, wherein the second end of the connecting rod forms a fork connected by a rod to the fixed fitting of the corresponding wheel.

5. Landing gear for light aircraft according to claim 2, wherein each connecting rod has a second end fixedly coupled to a fitting of the corresponding wheel.

6. Landing gear for light aircraft according to claim 1 wherein each damping member has a first end coupled with articulation capability to the ends of the base of the reinforcement.

7. Landing gear for light aircraft according to claim 6, wherein the first end of each damping member is coupled with articulation capability to the ends of the base of the reinforcement between two spaced lugs (8a, 8b) rigidly connected with the fuselage.

8. Landing gear for light aircraft according to claim 6, wherein each damping member has a second end angularly coupled fixedly to a fitting of the wheel.

9. Landing gear for light aircraft according to claim 6, wherein each damping member has a second end angularly coupled, with articulation capability, to a fitting of the wheel.

10. Landing gear for light aircraft according to claim 1 wherein the damping member is a hydraulic cylinder, made up of a barrel articulated to the ends of the base of the reinforcement, and a sliding rod coupled to a fitting of the wheel.

11. A light aircraft, Piper Cub® type, wherein it comprises a landing gear according to claim 1.

12. A light aircraft according to claim 11, wherein the landing gear is mounted on the original attachment elements equipping the fuselage part.

13. A light aircraft according to claim 11, wherein the landing gear is mounted on an independent support which could be attached on the part of the fuselage.

14. Method of mounting a landing gear according to claim 1 on a part of fuselage of a light aircraft, of Piper Cub® type, wherein the landing gear is mounted without modification of the original attachment elements equipping said fuselage part.

15. Method of mounting a landing gear according to claim 1 on a part of fuselage of a light aircraft, of Piper Cub® type, wherein the landing gear is mounted on an independent support which is attached on said fuselage part.
